(19) United States
(12) Patent Application Publication
(10) Pub. No.: US 2005/0280550 A1
(43) Pub. Date: Dec. 22, 2005

(54) Modal light-emitting device for mobile signal output devices methods and systems

(75) Inventors: Kerry Ivan Kurian, Cambridge, MA (US); Roy William Black, Cambridge, MA (US)

Correspondence Address: HARRINGTON & SMITH, LLP, 4 RESEARCH DRIVE, SHELTON, CT, 06484-6212, US

(73) Assignee: Ivan William Partners, Inc. Corporation

(21) Appl. No.: 10/947,625

(22) Filed: Sep. 23, 2004

Related U.S. Application Data
(60) Provisional application No. 60/580,060, filed on Jun. 16, 2004.
(60) Provisional application No. 60/587,914, filed on Jul. 14, 2004.

(51) Int. Cl. G09F 9/33

(52) U.S. Cl. 340/815.45; 340/815.42

(57) ABSTRACT

A method and device for illuminating a lighting element include an input for receiving an electrical signal from a separate mobile device, a lighting element, a memory for storing a plurality of user-selectable lighting modes, and a processor. The processor illuminates the lighting elements according to both the selected lighting mode and the electrical signal received from the separate device. The separate device may be a digital audio player, and the processor may vary the intensity of mode-specific lighting according to the signal from the audio player. Further, the selected mode may cause a strobe or text message to be displayed when another signal indicates that a page or email has been received. The lighting element may be an LED, an array of them, or a display screen with pixel lighting elements.

### PRIORITY STATEMENT

This Application claims priority to Provisional U.S. Patent Application No. 60/580,060, filed on Jun. 16^{th}, 2004, and to Provisional U.S. Patent Application No. 60/587,914, filed on Jul. 14^{th}, 2004, each of which are hereby incorporated by reference in their entirety.

### FIELD OF THE INVENTION

In general, the present invention relates to hardware modules that connect to and augment mobile signal output devices. In particular, the present invention relates to those hardware modules that contain a visible-light-emitting element under the control of electronics that operate in a plurality of modes.

### BACKGROUND

The general public in the United States has been using portable audio players for over a decade. These devices, first popularized by the Sony Walkman in 1979, include cassette tape players, AM/FM radio receivers, CD players, and—most recently—digital audio players, which are devices capable of rendering audio that is both stored in a digital format and accessible via electronic means not involving moving parts.

In response to the overwhelming popularity of portable digital audio players, and in particular the popularity of the Apple iPod series of portable digital audio players, a burgeoning industry has developed to supply hardware modules that connect to and augment the functionality of portable digital audio players. We will refer to such hardware modules as “add-on modules”. The various add-on modules presently available fall into the general classes of radio transmitters and receivers, microphones, remote controls, and external speakers.

Portable audio players are macroscopic things and, by definition, people can look at them. Apple Computer, in particular, clearly recognizes this and designs their iPod digital audio players to be pleasing on the eyes, not just the ears. As a result, the iPod appears to be as much fashion accessory as portable digital audio player. It is safe to say that this has, in part, led to the popularity of the iPod.

It is well known that a large portion of humans' brains is dedicated to the processing of visual input: Much of what people perceive is visual in nature. People enjoy looking at things that entertain, things that educate, things that alert, things that intrigue, things that are aesthetically pleasing, and so on. In short, there are many different reasons why people look at things.

As visually pleasing or informative as any one thing may be, it is self-evident that people like to see a variety of things. Televisions, for example, are interesting to look at because of the ever-changing images on their screens. Conversely, portable digital audio players, however stylish or attractive at first glance, are relatively static objects from a visual perspective.

Despite the current state of portable digital audio players, audio players with interesting visual displays have a rich history. For example, numerous in-dash automotive radios have intricate visual displays with lights that seem to dance to the audio. For another example, the immensely popular WinAmp personal computer application has numerous visualization software modules that perform different visual effects, which are synchronized to the audio being rendered. The fact that so many of these effects are built and contributed to the WinAmp user community by WinAmp users themselves, who are not compensated for their efforts, is a testament to the popularity of visualizations that are synchronized to audio.

While almost all people have considerable visual acuity, many people are not as interested in visualizations synchronized to audio as they are interested in being informed. Ambient Devices Inc., a Massachusetts corporation, has recognized this and has created a set of products based upon the concept of rendering digital information as “subtle changes in form, movement, sound, color or light.” Their Ambient Orb product, for example, resembles a snow globe with a frosted finish. A multi-color LED and electronics within the Orb cause the color and intensity of light emitted by the Orb to change with the value of digital data received, via wireless means, by said electronics.

While people are most often interested in employing visible-light-emitting devices to affect their own visual systems, for example to provide light for reading or images on a television, in some cases people use visible-light-emitting devices to alert others. For example, brake lights and turn signals on a car are used to alert the drivers of other cars. For another example, flashing beacons on bicycles and runners are used at night to alert automobile drivers.

In general, it is apparent that portable digital audio players are used in numerous situations where visible-light emission is desirable. For example, a runner at night with a portable digital audio player strapped to her arm could benefit from a flashing beacon. For another example, a college student desirous of a distraction could benefit from an amusing visualization accompanying the music he is listening to. For yet another example, an executive relaxing to music could benefit from a visual indication that an urgent email has arrived.

It would be useful to have a hardware module, connected to and augmenting a digital audio player, that emits light relevant to a given user in a given context.

Of course, even for a particular user, that user's context changes. The executive by day may become the runner by night. The college student may like visualizations with hot colors to energize him, but visualizations with cool colors while he's unwinding. Clearly, it would be useful if the hardware module mentioned in the previous paragraph also had a plurality of user-selectable modes, allowing the user to choose the particular visualization or visible-light-emitting function that the module performs at a given time.

The present invention addresses precisely this need, by providing a hardware module that connects to and augments a portable audio playback device, said module containing a visible-light-emitting element under the control of electronics that operate in a plurality of modes.

These and other features, aspects, and advantages of embodiments of the present invention will become apparent with reference to the following description in conjunction with the accompanying drawings. It is to be understood, however, that the drawings are designed solely for the purposes of illustration and not as a definition of the limits of the invention.

### SUMMARY OF THE INVENTION

Provided herein are methods and systems for providing a light-emitting device for a mobile signal output device wherein the light emission functionality is modal. In one aspect, the invention is a method that includes providing a processor that controls a light emitting sequence of a lighting element, and storing in a memory that is coupled to the processor information that is descriptive of a plurality of visual modes. A user-actuator is coupled to the processor such that actuation of the user-actuator selects one of the plurality of visual modes. An input is provided for receiving an electrical signal from a mobile signal output device. In response to receiving such an electrical signal, the lighting element is illuminated according to both the selected visual mode and the electrical signal received at the input. In some embodiments, the electrical signal may cause a variance in illumination intensity. In other embodiments or another mode of the embodiment immediately above, the mode may cause a strobe to flash or a text message to be displayed at the lighting element (which may be an arrayed screen of pixel elements) in response to receiving a signal from a node of a wireless communications network, such as to alert a user that a page or email has been sent to the user.

In accordance with another aspect of the invention, a portable multi-modal light emitting device is provided. As used herein, portable means handheld. The light-emitting device has a first input for receiving an electrical signal from a mobile signal output device. That the signal output device is mobile does not limit the invention to use only with signal output devices that are themselves portable though; for example, an electric guitar may serve as the mobile signal output device. The light-emitting device may be removably coupled to the mobile signal output device via a male/female jack, by a wireless link, or by other known means. The light-emitting device further has a light emission element and a memory for storing a plurality of lighting modes where each of the lighting modes is at minimum a set of processor instructions. The light-emitting device further has a mode control input for selecting one of the plurality of lighting modes, and it has a processor that is coupled to the first input, to the memory, and to the mode control input. The processor is for controlling the light emission element according to a signal received at the input and the user-selectable lighting mode. An actuator may be coupled to the mode control input by which a user may select the lighting mode, and the actuator may be disposed on the light emitting device or may be a separate actuator, such as one coupled to the device via a wireless link (e.g., electronic or infrared).

The mobile signal output device may be an audio player where the audio player may also be a portable device. The portable audio player may be carried in a pocket, held in the users hand, attached on the arm, worn around the neck, or carried by some other convenient means. The portable audio player may play pre-recorded music or pre-recorded voice. The portable audio player may also receive radio signals for the playing of terrestrial radio stations or the personal audio player may receive satellite signals for the playing of satellite radio. The portable audio player may be a digital audio player that may store digital recordings of pre-recorded music or pre-recorded voice. The portable audio player may provide a digital output signal, an analog output signal, a wireless output, cellular output, or other output signal as a stereo or mono signal.

The light-emitting device is capable of plurality of light-emitting modes that may provide light emission as a random pattern of color or monochromatic light. The light-emitting mode may also be a strobe where the strobe frequency is fixed, variable, user defined, or in response to the output signal of the mobile signal output device. The light-emitting mode may further provide text information that is in response to the processor executing a visualization mode. The text may be in response to the communication facility that may receive text from a wireless network, Bluetooth device, or external device input. The mode may be selected by an electrical signal from the mode change input that may provide an electrical signal to be interpreted by a processor as a command. The command may select a visualization mode which may be an executable file or an interpreted file that may direct the processor on the light emission sequence. The mode change input may be operated by a user and may be selected sequentially. By actuating the mode change input the next available visualization mode may be selected. The first visualization mode in the sequence may be selected after the last available visualization mode and may provide modes in a continual loop by pressing the mode change input. The modes may also be selected randomly where the user can select the visualization code randomly by pressing the mode change input and the visualization modes may be selected from a display. The user may select the visualization mode by scrolling through the available modes.

The light emission visualization modes may be enhanced by the audio signal from the mobile signal output device. The output signal may be interpreted by the processor and may provide varying light intensity to a light array of a plurality of individual light sources, a single color light source, strobe tube, or any other visible light emitting element. The light array may be displayed through a translucent cover that may be a diffuser of light. The light intensity may change for individual lights in the light array and may create a pattern that may be repetitive, random, or dependent on the visualization mode. The visualization mode may also be integral with the processor where the processor may contain a set number of modes that may not be capable of revision. Visualization modes may be enhanced by the audio signal of the mobile signal output device where the output signal may be interpreted by the processor and may provide a variation in light intensity.

The light-emitting device may provide a method of updating the light emitting visualization modes stored in memory. The memory storage device itself may be read only memory (ROM), random access memory (RAM), a hard drive, a tape drive, removal memory card, non-removal memory card or another applicable storage device. Visualization modes may be stored in the memory storage device and may be selected by the mode change input that may send a signal to the processor. On power up of the light-emitting device the first visualization mode, the last accessed visualization mode, or a random visualization code may be selected. Visualization modes may be updated or added using a programming input port connected to an external device. The programming input port may be connected to a computer, a handheld computer, a cell phone, a terrestrial receiver, a satellite receiver, memory card reader, or other external storage device. The visualization mode update may be executed by the external device or the mobile light-emitting device may execute the update.

The light-emitting device may be provided electrical power from a plurality of sources such as internal battery, external battery, external DC, external AC, or from the mobile signal output device output. There may be an input to receive an external power connection where the source may be DC, AC, or battery. The power may be provided by an internal or external DC converter that may be connected standard household current.

The visualization light may be provided by a plurality of light emitting diodes (LED) or other light source. To provide a plurality of light effects the light sources may be arranged in a screen where the screen may be in a light diffusing case, a light transparent case, an opaque case with holes, or other case design for creating the desired visual effect. The cases may be interchangeable by a user. The screen may be visible from all sides of the device or from less then all the sides of the device. The screen may be connected to the processor that may provide the visualization modes that are displayed on the screen. The visualization modes may provide random, non-random, or informational color patterns that may consist of patterns that are of a plurality of light intensities. The processor may retrieve the visualization from memory that may store a plurality of visualization modes, the communication facility, or from the programming input connection. The light emission from the screen may be enhanced by the output signal from the mobile signal output device where the output signal may vary the light intensity of the screen. The output signal may be applied to the screen along with the visualization mode as combined by the processor. There may be an input that accepts output signals from a mobile signal output device where the output signals are digital or analog. The output signals may be received by the processor and may combine the output signals with the visualization modes to determine function of the screen. The individual light sources, a single color light source, strobe tube, or any other visible light emitting element on the screen may have a plurality of light intensities that may result in a random or non-random pattern.

There may be an output that provides a device output signal for plurality of other devices where the output signal may be the same as the output signal received from the mobile signal output device. Additional mobile signal output devices may be stacked with the output of first device connected with the input of a second device. There may be no limit to the number of devices stacked in this manor. Devices that may be added may be another light-emitting device, headphones, a set of speakers, or other devices capable of receiving output from a mobile signal communication device.

There may be a communication facility such as a base station or other node of a wireless network (e.g., cellular, WLAN) that may be capable of receiving and transmitting signals. An antenna in the light-emitting device may receive a signal from a wireless computer network, a terrestrial radio transmission, a satellite transmission, cell phone, or other transmitting source. A received signal may provide output to the processor that may incorporate the input signal with the visualization mode and input signal from the mobile signal output device and provide output to the screen. The screen display may display a light pattern in response to the processor output. The light pattern may be a strobe, a predetermined color, a user defined color or text, or a text message derived from the received signal (e.g., text indicating the sender of an email message).

There may be an input to receive information descriptive of a state of the mobile signal output device, which the mobile signal output device transmits or otherwise communicates. The state may be the type of audio playing or if audio is playing. The light-emitting device may be able to pass this state information as an input to another external device, such as another light-emitting device in an electrically coupled stack of such devices. At least one of the stack of devices then displays according to the state of the mobile signal output device.

### BRIEF DESCRIPTION OF THE DRAWINGS

The present invention is described below more particularly with reference to the following drawing figures, which are not to scale except where stipulated.

FIG. 1 shows the mobile signal output device providing a signal to the light-emitting device.

FIG. 2 shows a schematic of the light-emitting device.

FIG. 3 shows an embodiment of the basic light-emitting device with the signal input and signal output.

FIG. 4 shows an embodiment of the basic light-emitting device with the mode change input.

FIG. 5 shows an embodiment of the basic light-emitting device with the mode change input and programming input port.

FIG. 6 shows an embodiment of the basic light-emitting device with the mode change input, programming input port, and communication facility.

FIG. 7 shows an embodiment of the basic light-emitting device with the mode change input, programming input port, and battery power source.

FIG. 8 shows an embodiment of the storage device for visualization modes.

FIG. 9 shows an embodiment of a device capable of holding a plurality of stacked light-emitting devices.

FIG. 10 shows an embodiment of the light-emitting device with a screen of light sources.

### DETAILED DESCRIPTION

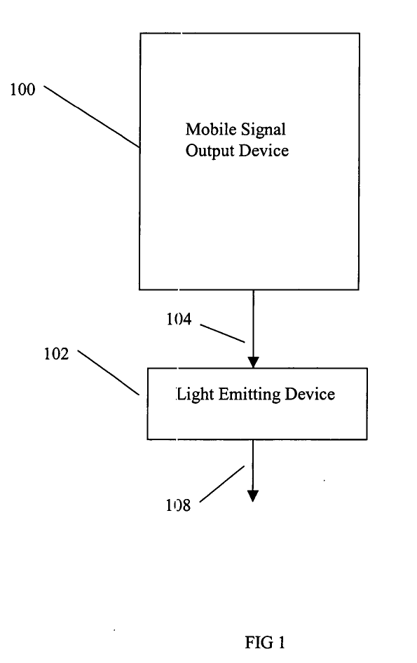

Referring to FIG. 1, the typical configuration of the mobile signal output device 100 and light-emitting device 102 is shown. Mobile signal output devices 100 have become a popular method for a user to conveniently carry the ability to listen to recorded or live music and voice. The mobile signal output device 100 may provide an output port to allow the user to insert portable head phones to listen to the music or voice and not interfere with other communications around the user. The mobile signal output device 100 may be an audio player where the audio player may be a personal device that may be small. The personal audio player may be carried in a pocket, held in the users hand, attached on the arm, worn around the neck, or carried by some other convenient means. The personal audio player may play pre-recorded music or pre-recorded voice. The personal audio player may also receive radio signals for the playing of terrestrial radio stations or the personal audio player may receive satellite signals for the playing of satellite radio. The personal audio player may be a digital audio player that may store digital recordings of pre-recorded music or pre-recorded voice. The personal audio player may play digital recordings in any file format, such as MP3, MPEG formats, .Wav, and other formats. The personal audio player may receive digital signals from terrestrial radio stations or satellite signal. The personal audio player may provide a digital output signal, an analog output signal, a wireless output, cellular output, or other output signal as a stereo or mono signal. The light-emitting device 102 may provide visual displays that may be coordinated with the mobile signal output device output 104. The light-emitting device 102 may be easily and conveniently attached to the mobile signal output device 100. In embodiments the personal digital audio player may be a personal digital audio player, such as the iPod from Apple Computer of Cupertino, Calif., or similar devices offered by other vendors.

Continuing to refer to FIG. 1, the mobile signal output device 100 may provide an output signal 104 to the light-emitting device 102. The light-emitting device 102 may provide a plurality of visual modes that will be discussed in detail in further figures. The light-emitting device 102 may provide an output port that may provide an output signal 108 that may be identical to the output 104 of the mobile signal output device 100. The light-emitting device 102 output port and output signal 108 may allow the user to enjoy the added visual displays of the light-emitting device 102 and still listen to the music or voice with person headphones.

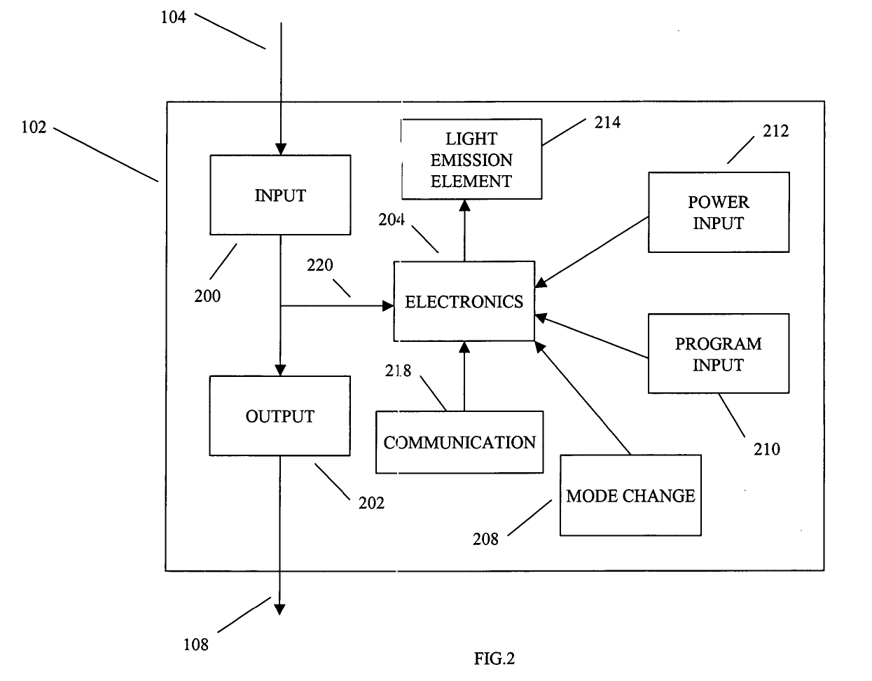

Referring to FIG. 2 a schematic is shown of the light-emitting device 102 with the various components of the device. The light-emitting device may contain a signal input port 200 to accept the mobile signal output device output 104. The input port may be directly connected to the light-emitting device output port 202 that may provide the light-emitting device output signal 108. The light-emitting device output signal 108 may be identical to the mobile signal output device output 104 and therefore maintaining the listening capabilities of the mobile signal output device 100. A connection 220 may be made from the output signal 104 to provide an output signal to the electronics 204. The electronics may receive input from a number of other components in the light-emitting device 102 such as the communication facility 218, mode change input 208, program input 210, and power input 212. The electronics 204 may also provide an output to the light emission elements 214 to provide a visual display. The electronics 204 may combine the selected visualization mode and output signal 104 from the mobile signal output device 100 to create visual displays on the light emission elements. The visualization mode may be selected from a data storage facility, which in embodiments may be memory storage, such as read only memory (ROM), random access memory (RAM), a hard drive, a tape drive, a USB drive, a dongle, a jump drive, a flash memory card, SRAM, DRAM, removable memory card, non-removable memory card or another applicable data storage facility. The visualization mode may be stored as an executable or interpreted file.

Continuing to refer to FIG. 2, the user may be able to select a visualization mode by using the mode change input 208. The visualization mode may be a particular sequence of digital instructions that may direct the electronics 204 to control the visible light emission element 214 according to a particular logical sequence. The sequence may be a function of the audio analysis performed by the electronics. The user may be able to access the visualization modes sequentially by using the mode change input 208 to select a visualization mode in sequence, once for every input into the mode change input 208. Indication that a visualization mode has been selected may be indicated by the selected mode being displayed on the light emission elements 214. The visualization mode may also be selected randomly by using the mode change input 208 to scroll through visualization modes shown on a display. Once a visualization mode has been selected, the electronics 204 may combine the actions of the visualization mode file with the mobile signal output device output 104 to create a visual effect on the light emission element 214. The light emission element 214 may be constructed of a plurality of individual light sources, a single color light source, strobe tube, or any other visible light emitting element capable of displaying color or monochromatic light, arranged as a screen. The screen may be applied to all sides of the light-emitting device 102 or on less than all of the sides of the light-emitting device 102. The visual effect may be a set pattern, random pattern, a strobe, text or other visualization that may depend on the visualization mode selected. The visual effect may be enhanced by the mobile signal output device 100 output 104. The output 104 may be combined with the visualization mode to provide a plurality of light colors and intensities to the light emission element 214 that may provide for a light pattern in response to the music or voice input.

Continuing to refer to FIG. 2, the program input port 210 may provide input to the electronics 204. The visualization modes may be stored on the previously mentioned storage devices. The program input port 210 may be connected to an external device for the update, addition, or deletion of visualization modes. The external devices may be a computer, a handheld computer, PDA, a cell phone, a terrestrial receiver, a satellite receiver, memory card reader, or other external storage device. The external device may be able to add, update, or remove visualization modes in the storage device of the light-emitting device 102. On power up of the light-emitting device the first visualization mode, the last accessed visualization mode, or a random visualization code may be selected.

Continuing to refer to FIG. 2, the communication facility 218 may provide additional input to the electronics 204. The communication facility 218 may be capable of receiving or transmitting information through an antenna. The antenna in the communication facility 218 may receive a signal from a wireless computer network, a terrestrial radio transmission, a satellite transmission, a node of a wireless communications system (e.g., base station, mobile telephone, node of a WLAN, and the like), or other transmitting source. The received signal may provide information to the light emission element 214 in the form of an alert light pattern or text. An alert light pattern may be a predefined or user defined light pattern that may alert the user that a transmitting device may need attention. In an embodiment the light-emitting device 102 may receive a transmission from a wireless network that an email has just been received. The light pattern may be a color pattern using a visualization mode or may be a strobe light. The communication facility 218 may also be able to send text to the electronics 204 and light emissions element 214 for display. The text may be a monochromatic or color display and may be stationary or may scroll around the light emission element 214 and may indicate the external device that is requesting attention.

Continuing to refer to FIG. 2, the light-emitting device 102 may be provided electrical power from a power input 212. The power input 212 may be provided by a plurality of sources such as internal battery, external battery, external DC, external AC, or from the mobile signal output device output. There may be an input to receive an external power connection where the source may be DC, AC, or battery. The power may be provided by an internal or external DC converter that may be connected standard household current.

Continuing to refer to FIG. 2, the embodiment of the light-emitting device 102 may use some or all of the components described in FIG. 2. A basic embodiment may be fully self-contained, with only the needed components to receive input and process the information to the light emission element 214 and not provide any user interfacing, running in an automatic state. Components may be added to increase the user functionality of the light-emitting device 102 to include the mode change input 208, program input port 210, communication facility 218, and power input 212. Several embodiments are described in the next several figures, but the figures are not inclusive of all embodiments of the light-emitting device 102.

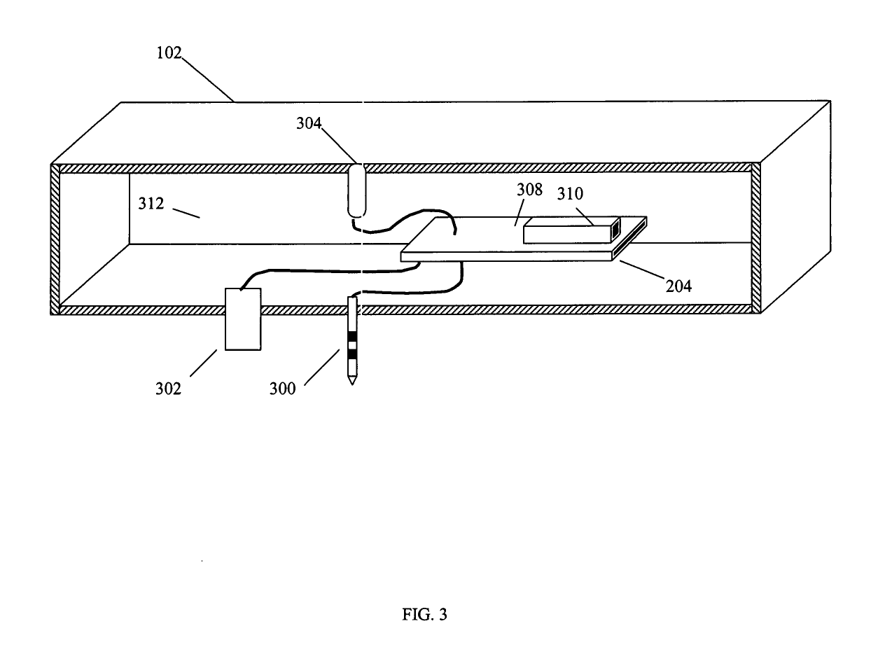

Referring to FIG. 3 an embodiment of a sectional view of the light-emitting device 102 is shown. This embodiment may be considered a basic configuration that may be fully self-contained with no external interaction by a user. The electronics 204 may consist of a printed circuit board 308 and a processor 310 that may process all inputs to the printed circuit board 308. An input port 300 may receive an output signal 104 and the signal may be connected to the printed circuit board 308. The output signal 104 may be passed through to an output port 304 as an identical signal as received at the input port 300. The light-emitting device 102 may also have a mobile signal output device 100 connector 302 that may contain connections to the battery of the mobile signal output device 100 to power the light-emitting device 102. The input port 300, the output port 304, and the connector 302 may be standard configuration, such as the tri-pole pin as shown for the input port 300, to better facilitate coupling to a variety of legacy mobile signal output devices 100 that are already in use. In an embodiment the connector 302 may also contain connections that provide the state of the mobile signal output device 100 and may influence the operation of the light-emitting device 102 such as an automatic on feature. Additional mobile signal output devices may be stacked with the output of first device connected with the input of a second device. There may be no limit to the number of devices stacked in this manner. Synchronization and data signals may be transmitted between stacked light emitting modules 102 by the connector 302 and may allow for real time coordination of visualization modes and may transfer the visualization mode from one light-emitting device to another. Devices that may be added may be another light-emitting device, headphones, a set of speakers, or other devices capable of receiving output from a mobile signal communication device.

The processor 310 and printed circuit board 308 may also be connected to the light emission element 312 in the light-emitting device 102. The processor may control all functions of the light emission element, such as to display visualizations. The processor 310 may access memory as described in FIG. 2 to provide visualization modes to the light emission element 312. In this embodiment the processor 310 may control all of the visualization modes with no user interaction. The processor may either sequentially or randomly access the internal visualization modes and display them to the light emission element at set or random intervals.

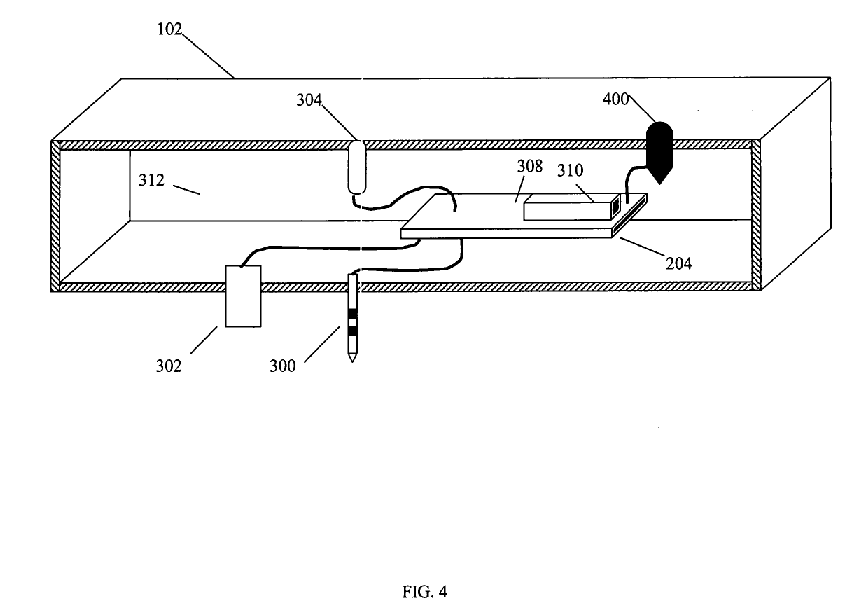

Referring to FIG. 4 an embodiment is shown of the light-emitting device 102 that is the same as the embodiment described in FIG. 3, but an additional mode control input 400 is shown. The mode control input 400 may be a push button switch, a toggle switch, a pressure sensitive switch, a touch screen switch, or other type of control that may send a signal to the processor 310. The mode control input 400 may be used to select the visualization mode that may be displayed on the light emission element 312. The processor 310 may contain memory that stores the visualization modes. The visualization mode may be selected from a data storage facility, which may be any kind of storage facility described above in connection with FIG. 2, such as memory storage that may be read only memory (ROM), random access memory (RAM), a hard drive, a tape drive, jump drive, dongle, flash memory device, USB drive, removable memory card, non-removable memory card or another applicable storage device. The visualization mode may be stored as an executable or interpreted file.

Continuing to refer to FIG. 4, the user may be able to select a visualization mode by using the mode change input 400. The user may be able to access the visualization modes sequentially by using the mode change input 400 to select a visualization mode in sequence, one visualization mode for every input into the mode change input 400. Indication that a visualization mode has been selected may be by the selected mode being displayed on the light emission elements 312. The visualization mode may also be selected randomly by using the mode change input 400 to scroll through visualization modes shown on a display. Once a visualization mode has been selected, the processor 310 may combine the actions of the visualization mode file with the mobile output signal device output 104 to create a visual effect on the light emission element 312. The visualization mode may be a set pattern, random pattern, a strobe, text or other visualization that may depend on the visualization mode selected. The visualization mode may be enhanced by the mobile signal output device 100 output 104. The output 104 may be combined with the visualization mode to provide a plurality of light colors and intensities to the light emission element 312 that may provide for a light pattern in response to the music or voice input.

Where two or more light emitting devices 102 according to the present invention are stacked, mode selection on only one light emitting device 102 may operate to select that same mode on all stacked light emitting devices 102. This aspect is particularly advantageous if only the topmost light emitting device 102 of the stack has an actuator that is exposed for ready selection by a user.

It is noted that the mode control input 400, or actuator, need not be disposed within a same housing as the processor 310 and/or the light emission element 312. In one embodiment where they are disposed within a common housing, the mode control input 400 is directly coupled to a push-button actuator where each successive depression by a user selects a different mode. In another embodiment, the actuator may be remotely located, such as a musician's foot-operated pedal actuator. The pedal may be coupled to the mode control input 400 via a hardwired connection, or preferably via a wireless connection protocol such as Bluetooth or WLAN. However coupled, actuation of the pedal by the user is sensed as an input at the mode control input 400, the selected mode is changed, and the light emission element displays accordingly. Where a plurality of light emitting devices are stacked, such a remote actuator allows dynamic mode selection for each of the stacked devices 102, even if an additional push-button actuator on the housing or a stacked device is not accessible due to the stacking.

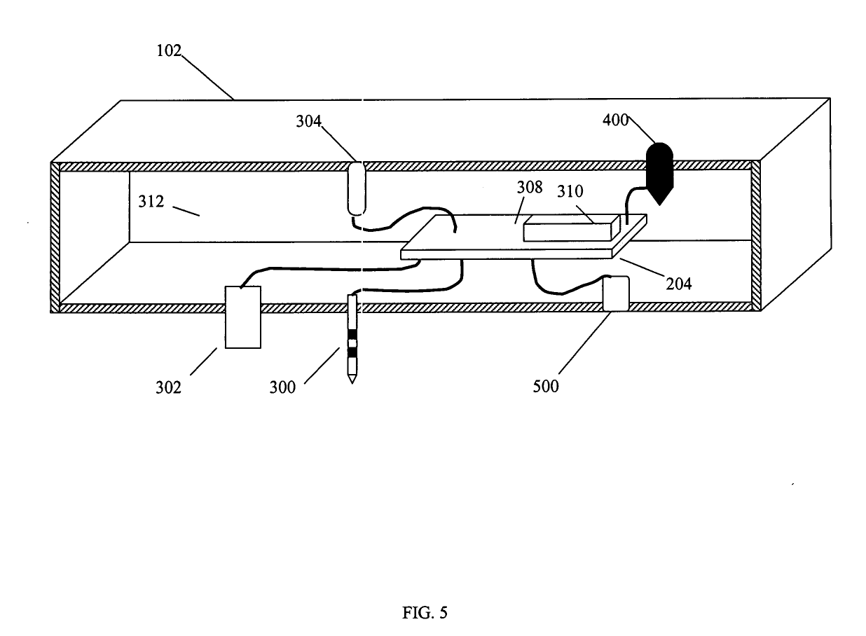

Referring to FIG. 5 an embodiment is shown of the light-emitting device 102 that is the same as the embodiment described in FIG. 4 but an additional program update port 500 is shown. The program input port 500 may be an industry standard connection such as a serial port, USB 1.0, USB 2.0, phone jack, network jack, or other connection that may provide data input to the processor 310. The visualization modes may be stored on the previously discussed storage devices. The program input port 500 may be connected to an external device for the update, deletion, or addition of visualization modes. The external devices may be a computer, a handheld computer, laptop, transceiver, PDA, a cell phone, a terrestrial receiver, a satellite receiver, memory card reader, or other external storage device. The external device may be able to add, update, or remove visualization modes in the storage device of the light-emitting device 102. The external device may provide an interface that may provide the user access to the visualization modes on the light-emitting device 102. The external device may be capable of initiating the visualization mode update or the light-emitting device 102 may initialize the update process. The program input port 500 may be capable to communicate with a stand alone device or a device that may communicate through a network.

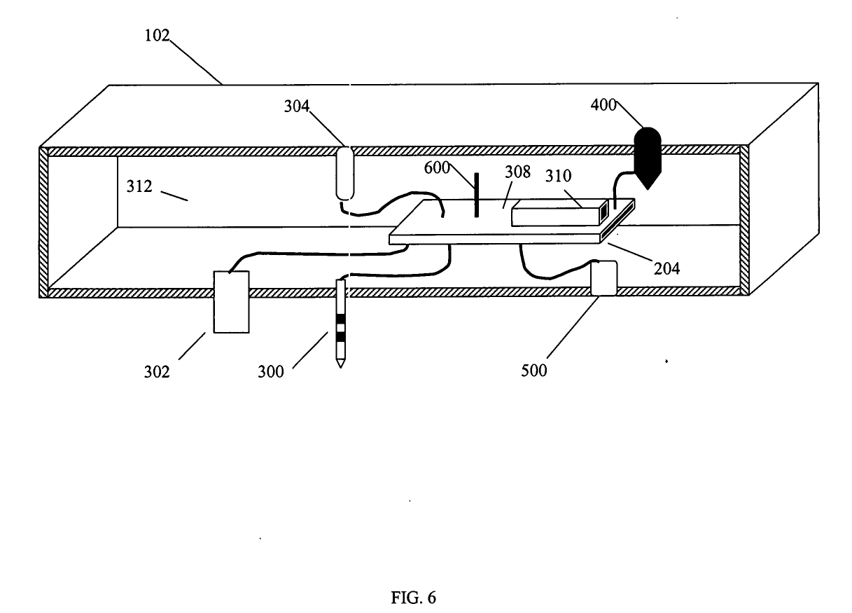

Referring to FIG. 6 an embodiment is shown of the light-emitting device 102 that is the same as the embodiment described in FIG. 5 but an additional communication facility 600 is shown. The communication facility 600 may provide additional input to the processor 310. The communication facility 600 may be capable of receiving or transmitting information through an antenna. The antenna may be a wire, bar, patch, or other antenna device capable of receiving signals. The antenna in the communication facility 600 may receive a signal from a wireless computer network, a terrestrial radio transmission, a satellite transmission, cell phone, or other transmitting source. The received signal may provide information to the light emission element 312 in the form of an alert light pattern or text. An alert light pattern may be a predefined or user defined light pattern that may alert the user that a transmitting device may need attention. In an embodiment, the light-emitting device 102 may receive a transmission from a wireless network that an email has just been received. The light pattern may be a color pattern using a visualization mode or may be a strobe light. The communication facility 600 may also be able to send text to the processor and light emission element 312 for display. The text may be a monochromatic or color display and may be stationary or may scroll around the light emission element 312.

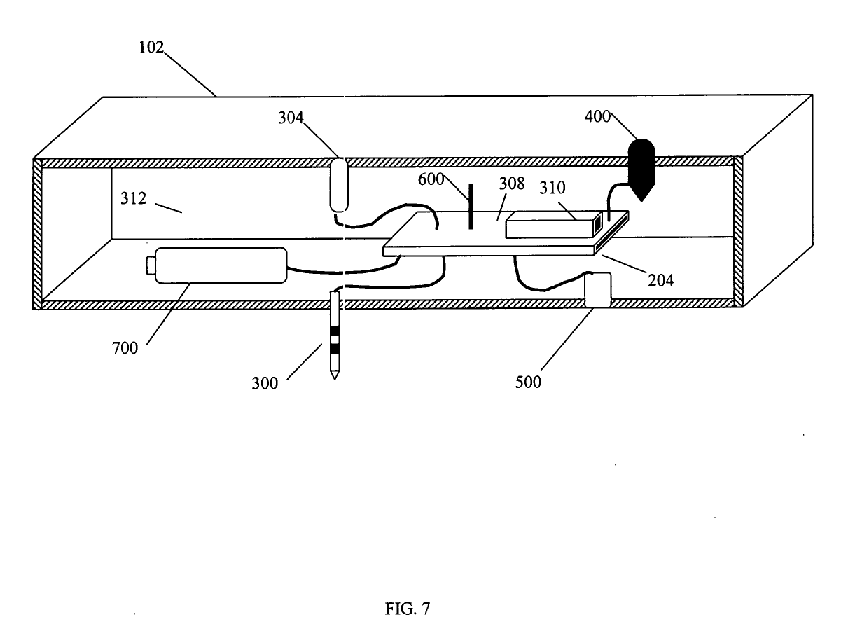

Referring to FIG. 7 an embodiment is shown of the light-emitting device 102 that is similar to the embodiment described in FIG. 6 but an additional battery 700 is shown. The power may be provided by an internal battery 700 connected to the printed circuit board 308. The light-emitting device 102 may also use a plurality of other power sources for the processor 310 and light emission element 312. The power input 212 may be provided by a plurality of sources such as internal battery, external battery, external DC, external AC, or from the mobile signal output device output. There may be an input to receive an external power connection where the source may be DC, AC, or battery. The power may be provided by an internal or external DC converter that may be connected standard household current.

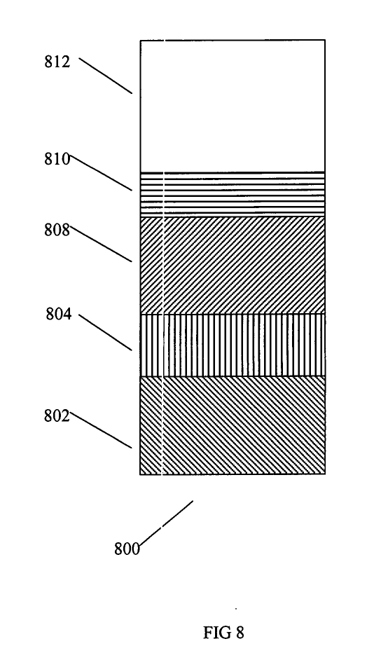

In referring to FIG. 8, an embodiment of memory storage 800 for visualization modes is shown. The memory storage 800 may be may be read only memory (ROM), random access memory (RAM), a hard drive, a tape drive, removal memory card, non-removal memory card or another applicable storage device. The visualization mode may be stored as an executable or interpreted file. The visualization modes may be of different file sizes as stored on the memory storage 800 and may be stored using consecutive memory addresses. In an embodiment the visualization mode 1 802 may be adjacent to visualization 2 804 and in sequence to visualization 4 810. The processor 310 may access the memory storage 800 to retrieve a stored visualization mode. In an embodiment the processor 310 may be executing visualization mode 1 802 when a user selects visualization mode 2 804 by actuating the mode control input 400. The processor 310 may replace the executing visualization mode 1 802 with visualization mode 2 804 and then execute visualization mode 2 804. In an embodiment, the user may be able to search through the available visualization modes by providing input to the mode change input 400. In an embodiment the first visualization mode may be visualization mode 1 802, visualization mode 2 804 may be selected next in the sequence of user input. The sequence may continue to visualization mode 3 808 and visualization mode 4 810 that may be the last stored visualization mode on the memory storage 800 with blank storage space 812 after the visualization mode 4 810. In an embodiment, the user may select a next visualization mode after the visualization mode 4 810 had been selected. The processor 310 may select visualization mode 1 802 after the last visualization mode has been selected and may create a continuous visualization mode scrolling loop based on the user input. In an embodiment, the user may be aware of the visualization mode change by the visualization mode display on the light emission element.

In another embodiment, the user may be able to scroll through the available visualization modes by use of a display on the light-emitting device 102. The display may be an LCD, LED, plasma, or other visual display to provide a visualization of the available visualization modes. In an embodiment, as the user provides input to the mode change input, the visualization modes may be displayed in a sequence from visualization mode 1 802 through visualization mode 4 810. The user may be able to scroll forwards or backwards through the visualization modes and then may select the desired mode.

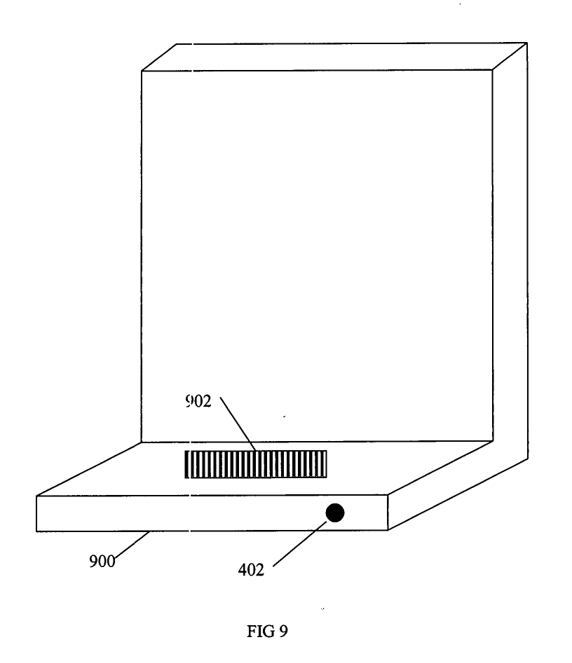

Referring to FIG. 9 an embodiment of the light-emitting device 900 is shown that may be shaped to fit a particular type of mobile signal output device 100. The light-emitting device 100 may be shaped such that it provides a bottom and back to the mobile signal output device 100. This may allow the back and bottom of the light-emitting device 900 to be covered by the light emission element 312 for display of the visualization modes. In an embodiment, the light-emitting device 900 may have a dock connector 902 that may dock with the mobile signal output device 100. The dock connector 902 may provide electrical connections that may provide data input and data output, line level output signal, and power input and output. In an embodiment, these connections may allow the light-emitting device 102 to communicate with the mobile signal output device 100 as to the state of the mobile signal output device 100. The state information may allow the light-emitting device to modify operation modes dependent on the user input to the mobile signal output device 100.

Continuing to refer to FIG. 9, the embodiment of the light-emitting device 900 may have some or all of the components described in FIG. 2.

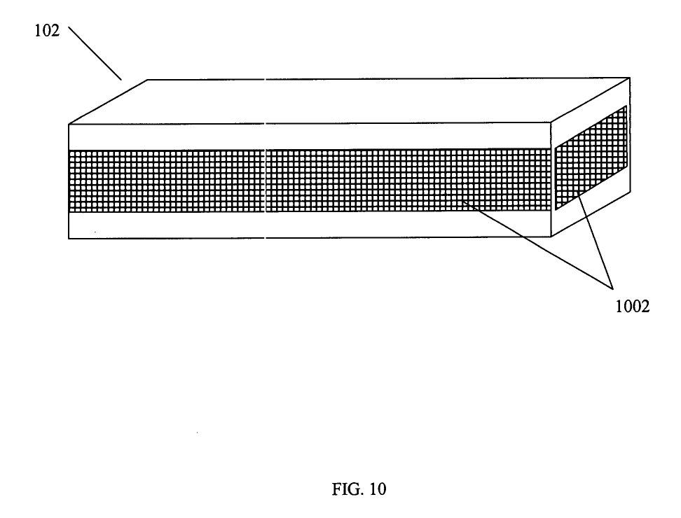

Referring to FIG. 10 an embodiment is shown of the light-emitting device 102 with light emission elements 1002 on the sides. The light emission element 1002 may be constructed of a plurality of individual light sources, a single color light source, strobe tube, or any other visible light emitting element capable of displaying color or monochromatic light, arranged as a screen. The screen may be applied to all sides of the light-emitting device 102 or on less than all of the sides of the light-emitting device 102. The visual effect may be a set pattern, random pattern, a strobe, text or other visualization that may depend on the visualization mode selected. The visual effect may be enhanced by the mobile signal output device 100 output 104. The output 104 may be combined with the visualization mode to provide a plurality of light colors and intensities to the light emission element 1002 that may provide for a light pattern in response to the music or voice input.

Continuing to refer to FIG. 10, in an embodiment, providing different external covers over the light emission elements 1002 may further alter the effect of the light emission element 1002. In an embodiment a translucent cover may defuse the light and may provide muted colors and patterns on the cover as a display. In another embodiment a clear cover may provide vivid colors and patterns on the cover as a display and may also allow displaying text on the light emission elements 1002. Text display may be in response to a selected visualization mode or from a message received from the communication facility 600. In another embodiment, a solid cover may be provided with a series of holes that the light emission elements 1002 may be visible through. A person knowledgeable in the art would be able to provide a plurality of cover materials and designs that may provide a plurality of displays. In an embodiment, interchangeable covers may be provided and may allow the user to change the cover based on the display type desired.

While there has been illustrated and described what is at present considered to be preferred and alternative embodiments of the claimed invention, it will be appreciated that numerous changes and modifications are likely to occur to those skilled in the art. It is intended in the appended claims to cover all those changes and modifications that fall within the spirit and scope of the claimed invention.

1. A method for illuminating a lighting element comprising:
providing a processor that controls a light emitting sequence of a lighting element;
storing in a memory that is coupled to the processor information that is descriptive of a plurality of visual modes;
coupling a user-actuator to the processor such that actuation of the user-actuator selects one of the plurality of visual modes;
providing an input for receiving an electrical signal from a mobile signal output device; and
in response to receiving an electrical signal from a mobile signal output device at the input, illuminating the lighting element according to both the selected visual mode and the electrical signal received at the input.

2. The method of claim 1, wherein the mobile signal output device is removably coupled to the input, and wherein said mobile signal output device is selected from the group: an audio player, a musical instrument, a microphone, and a sound-effect device.

3. The method of claim 2, wherein the mobile signal output device is a digital audio player.

4. The method of claim 1, wherein illuminating the lighting element according to both the selected visual mode and the electrical signal received at the input comprises illuminating the lighting element according to a first light emitting sequence when a first mode is selected, and according to a second light emitting sequence when a second mode is selected.

5. The method of claim 4, wherein at least one of the light emitting sequences comprises a random pattern.

6. The method of claim 4, wherein the first and second light emitting sequences differs at least in color.

7. The method of claim 1, wherein illuminating the lighting element according to both the selected visual mode and the electrical signal received at the input comprises:
illuminating the lighting element according to a first visual display in response to an electrical signal received at the input from the mobile signal output device and
illuminating the lighting element according to a second visual display in response to a signal received from a node of a wireless communications network.

8. The method of claim 7, wherein the second visual display comprises a strobe.

9. The method of claim 7, wherein the second visual display comprises text information.

10. The method of claim 9, wherein at least a portion of the text information is received from the node of the wireless communications network.

11. The method of claim 7, wherein the node comprises a base station.

12. The method of claim 1, wherein the electrical signal comprises an electrical version of an audio signal, and illuminating the lighting element according to both the selected visual mode and the electrical signal received at the input comprises using the electrical signal version of the audio signal to vary a light intensity determined by the selected visual mode.

13. The method of claim 1, wherein the lighting element comprises an array of discrete light sources.

14. The method of claim 13, wherein the array is displayed through a translucent cover.

15. The method of claim 1, further comprising altering the plurality of visual modes stored in the memory at least by receiving a new visual mode via a second input.

16. A portable multi-modal light emitting device comprising:
a first input for receiving an electrical signal from a mobile signal output device;
a light emission element;
a memory for storing a plurality of lighting modes, each of said lighting modes comprising a set of processor instructions;
a mode control input for selecting one of the plurality of lighting modes; and
a processor coupled to the input, the memory, and the mode control input for controlling the light emission element according to a signal received at the first input and at the mode control input.

17. The portable light emitting device of claim 16, wherein the first input comprises a contactor for removably coupling to a mobile signal output device, said mobile signal output device being selected from the group: an audio player, a musical instrument, a microphone, and a sound-effect device.

18. The portable light emitting device of claim 17, wherein the mobile signal output device comprises a digital audio player.

19. The portable light emitting device of claim 16, wherein at least one set of processor instructions causes a random pattern in the light emission element.

20. The portable light emitting device of claim 16, wherein one set of processor instructions causes a first color in the light emission element and another set of processor instructions causes a second color in the light emission element.

21. The portable light emitting device of claim 16 further comprising a second input for receiving a signal from a node of a wireless communications network, and wherein
for at least one lighting mode, the processor illuminates the lighting element according to a first visual display in response to an electrical signal received at the first input and the processor illuminates the lighting element according to a second visual display in response to a signal received at the second input.

22. The portable light emitting device of claim 21, wherein the second visual display comprises a strobe.

23. The portable light emitting device of claim 21, wherein the second visual display comprises text information.

24. The portable light emitting device of claim 23, wherein at least a portion of the text information is received at the second input.

25. The portable light emitting device of claim 21, wherein the node comprises a base station.

26. The portable light emitting device of claim 16, wherein the electrical signal comprises an electrical version of an audio signal, and the processor controls the light emission element according to least one mode and further varies an intensity of the light emission element according to the electrical version of the audio signal.

27. The portable light emitting device of claim 16 wherein the lighting element comprises an array of discrete light sources.

28. The portable light-emitting device of claim 26, further comprising a translucent cover overlying the array.

29. The portable light emitting device of claim 16, further comprising a second input coupled to the memory for receiving at least a new lighting mode.

30. The portable light emitting device of claim 16, further comprising an actuator coupled to the mode control input by which a user may select one of the plurality of lighting modes.

31. The portable light emitting device of claim 16 coupled through a second input to another portable light emitting device of claim 16, said portable light emitting devices comprising a stack of devices having at least one actuator coupled to the mode control input of at least one device of the stack, wherein the actuator is for selecting one of the plurality of lighting modes in each of the portable light emitting devices of the stack.
